(19) United States
(12) Patent Application Publication
(10) Pub. No.: US 2006/0188812 A1
(43) Pub. Date: Aug. 24, 2006

(54) Phenolic hydroxyl group-containing copolymer and radiation-sensitive resin composition

(76) Inventors: Tomoki Nagai, Tokyo (JP); Hirotaka Mizuno, Tokyo (JP); Kouichirou Yoshida, Tokyo (JP); Yoshikazu Yamaguchi, Tokyo (JP); Daisuke Shimizu, Tokyo (JP); Nobuji Matsumura, Tokyo (JP); Satoru Nishiyama, Tokyo (JP); Toshiyuki Kai, Tokyo (JP)

Correspondence Address: MERCHANT & GOULD PC, P.O. BOX 2903, MINNEAPOLIS, MN, 55402-0903, US

(21) Appl. No.: 11/356,003

(22) Filed: Feb. 17, 2006

(30) Foreign Application Priority Data
Feb. 21, 2005 (JP) 2005-043442
Aug. 31, 2005 (JP) 2005-250489

(51) Int. Cl. G03C 1/76

(52) U.S. Cl. 430/270.1

(57) ABSTRACT

A copolymer is provided which exhibits improved resolution, sensitivity, and exposure latitude and excels in pattern collapse margin. The copolymer contains a recurring unit which is hydrolyzed completely an acid-labile group with an acid after copolymerizing a monomer of the following formula(1) and a recurring unit which is hydrolyzed partially acid-labile group with an acid after copolymerizing a monomer of the following formula (2), 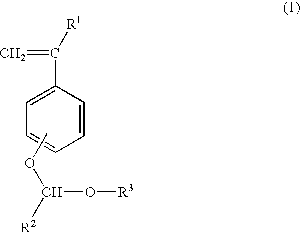
wherein R¹ represents a hydrogen atom or a methyl group, and R² and R³ represent saturated hydrocarbon groups having 1-4 carbon atoms or bond together to form a cyclic ether having 3-7 carbon atoms, 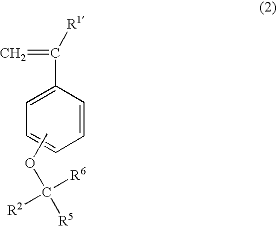
wherein R^{1′} represents a hydrogen atom or a methyl group, and R⁴, R⁵, and R⁶ represent saturated hydrocarbon groups having 1-4 carbon atoms.

### BACKGROUND OF THE INVENTION

The present invention relates to a copolymer having a phenolic hydroxyl group and a radiation-sensitive resin composition using the copolymer as an acid-labile group-containing resin, used as a chemically-amplified resist suitable for microfabrication utilizing various types of radiation, particularly, (extreme) far ultraviolet rays such as a KrF excimer laser, ArF excimer laser, F₂ excimer laser, or EUV, X-rays such as synchrotron radiation, and charged particle rays such as electron beams, and the like.

In the field of microfabrication represented by fabrication of integrated circuit devices, photolithographic technology enabling microfabrication with a line width of about 200 nm or less has been demanded in recent years in order to achieve a higher degree of integration.

Use of radiation with a short wavelength enabling microfabrication with a line width level of about 200 nm or less has been studied. As the radiation having such a short wavelength, deep ultraviolet rays such as a bright line spectrum of a mercury lamp and an excimer laser, X-rays, an electron beams, and the like can be given, for example. Of these, a KrF excimer laser (wavelength: 248 nm), an ArF excimer laser (wavelength: 193 nm), an F₂ excimer laser (wavelength: 157 nm), EUV (wavelength: 13 nm, etc., extreme ultraviolet radiation), electron beams, and the like are gaining attention.

As a radiation-sensitive resin composition applicable to short wavelength radiation, a number of compositions utilizing a chemical amplification effect brought about by a component having an acid-labile functional group and a photoacid generator which generates an acid upon irradiation (hereinafter called “exposure”) have been proposed.

As the chemically-amplified radiation-sensitive composition, JP-B-02-27660 discloses a composition comprising a resin containing a t-butyl ester group of carboxylic acid or a t-butylcarbonate group of phenol and a photoacid generator. This composition utilizes the effect of the resin to release a t-butyl ester group or t-butyl carbonate group by the action of an acid generated upon exposure to form an acidic group such as a carboxyl group or a phenolic hydroxyl group, which renders an exposed area on a resist film readily soluble in an alkaline developer.

A copolymer containing a hydroxystyrene recurring unit and a recurring unit in which the hydrogen atom in the hydroxyl group of hydroxystyrene is replaced with a tertiary alkyl group is known to be used in a resist pattern forming method capable of producing a minute resist pattern without fail while ensuring high resolution, even if a long time is allocated to PED (JP-A-10-319596).

Further, as a resist material excelling in light transmittance in the neighborhood of 248.4 nm, storage stability, and the like, a copolymer having a recurring unit of a hydroxystyrene derivative with an acetal or ketal group, a hydroxystyrene recurring unit, and a recurring unit of a styrene derivative is known (JP-A-8-123032).

Characteristics demanded for a photo resist are becoming severer along with a rapid miniaturization trend of photolithography process. Not only increase in resolution, sensitivity, and exposure latitude that has been conventionally targeted, but also excelling in pattern collapse margin in resist pattern formation is demanded.

However, excelling in pattern collapse margin and increasing in exposure latitude are difficult if a conventional copolymer containing a hydroxystyrene recurring unit is used.

### SUMMARY OF THE INVENTION

An object of the present invention is to provide a radiation-sensitive resin composition which, when used as a chemically amplified resist sensitive to far ultraviolet rays represented by a KrF excimer laser, ArF excimer laser, or F₂ excimer laser, exhibits improved resolution, sensitivity, and exposure latitude, and excels in pattern collapse margin in resist pattern formation, and a copolymer having a phenolic hydroxyl group prepared by a novel polymer synthesis method, and useful as a resin component of the composition.

The phenolic hydroxyl group-containing copolymer of the present invention is a copolymer containing a recurring unit which is hydrolyzed after copolymerizing a monomer of the following formula (1) and a recurring unit which is hydrolyzed after copolymerizing a monomer of the following formula (2). In particular, the copolymer is prepared by hydrolyzing completely an acid-labile group of the monomer of the formula(1), and hydrolyzing partially acid-labile group of the monomer of the formula(2), 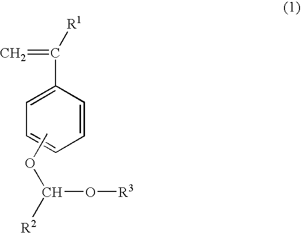
wherein R¹ represents a hydrogen atom or a methyl group, and R² and R³ represent saturated hydrocarbon groups having 1-4 carbon atoms or bond together to form a cyclic ether having 3-7 carbon atoms. 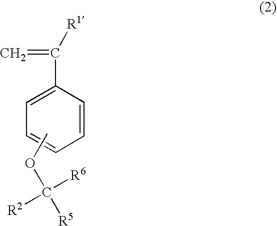
wherein R^{1′} represents a hydrogen atom or a methyl group, and R⁴, R⁵, and R⁶ represent saturated hydrocarbon groups having 1-4 carbon atoms.

The copolymer of the present invention, wherein a polystyrene-reduced weight average molecular weight of the copolymer determined by gel permeation chromatography (GPC) is not less than 500 and less than 12,000, preferably not less than 500 and less than 10,000, and more preferably not less than 500 and not more than 2,000. The polystyrene-reduced weight average molecular weight of the copolymer is not less than 500 and not more than 2,000, it is particularly preferable as a copolymer for electron beams or (extreme) far ultraviolet rays such as EUV.

The copolymer further comprises styrene monomer with monomers of the formula (1) and (2).

The copolymer prepared by anionic polymerization of the monomers.

And a catalyst used in the anionic polymerization is a butyllithium.

The acid is p-toluenesulfonic acid or hydrochloric acid.

The radiation-sensitive resin composition of the present invention is characterized by comprising an acid-labile group-containing resin which is insoluble or scarcely soluble in alkali, but becomes alkali soluble by the action of an acid, and a photoacid generator.

The copolymer of the present invention is prepared by copolymerizing monomers of the formula(1) and the formula(2) and hydrolyzing the resulting copolymer with an acid, and hydrolyzing completely an acid-labile group of the monomer of the formula(1), and hydrolyzing partially acid-labile group of the monomer of the formula(2). The hydrolysis reaction of the monomer of the formula (1) easily proceeds even in weakly acidic conditions due to low activation energy as compared with the hydrolysis reaction of butoxystyrene and the like using a strong acid such as hydrochloric acid and sulfuric acid. As a result, the recurring unit having a phenolic hydroxyl group on the side chain prepared by the hydrolysis reaction can be easily formed in the copolymer.

The radiation-sensitive resin composition using the copolymer of the present invention ensures improved resolution, sensitivity, and exposure latitude, and excels in pattern collapse margin in resist pattern formation.

### BRIEF DESCRIPTION OF THE DRAWINGS

FIG. 1 is schematic views of line pattern.

FIG. 2 is schematic views of pattern profiles.

FIG. 3 is FT-IR chart of the copolymer.

### DETAILED DESCRIPTION OF THE PREFERRED EMBODIMENTS

R² and R³ in the monomer of the formula (1) represent saturated hydrocarbon groups having 1-4 carbon atoms or bond together to form a cyclic ether group having 3-7 carbon atoms.

As examples of the saturated hydrocarbon groups having 1-4 carbon atoms, alkyl groups such as a methyl group, ethyl group, n-propyl group, i-propyl group, n-butyl group, 2-methylpropyl group, 1-methylpropyl group, and t-butyl group can be given.

Examples of the cyclic ether having 3-7 carbon atoms include a tetrahydrofuranyl group, tetrahydropyranyl group, and the like.

As suitable monomers shown by the formula (1), p-(1-ethoxy) ethoxystyrene, tetrahydroxyfuranyloxystyrene, tetrahydropyranyloxystyrene, and the like can be given.

As the recurring unit having an acid-labile group, recurring units obtainable from a recurring unit derived by cleavage of a polymerizable unsaturated bond in a recurring unit having one or more acidic functional groups such as a phenolic hydroxyl group or carboxyl group, by replacing a hydrogen atom in the phenolic hydroxyl group or carboxyl group with an acid-labile group, can be given. Of these, the recurring unit obtained by replacing the hydrogen atom in a phenolic hydroxyl group with an acid-labile group is preferable, with a recurring unit prepared by copolymerizing a monomer of the formula (2) being particularly preferable.

R⁴, R⁵, and R⁶ in the formula (2) represent saturated hydrocarbon groups having 1-4 carbon atoms. As examples of the saturated hydrocarbon groups having 1-4 carbon atoms, monovalent alkyl groups such as a methyl group, ethyl group, n-propyl group, i-propyl group, n-butyl group, 2-methylpropyl group, 1-methylpropyl group, and t-butyl group can be given.

As suitable monomers shown by the formula (2), p-t-butoxystyrene, m-t-butoxystyrene, p-t-amyloxystyrene, p-1-methoxycyclohexyloxystyrene, p-1-ethylcyclohexyloxystyrene, p-1-methylcyclopentyloxystyrene, p-1-ethylcyclopentyloxystyrene, and the like can be given.

The copolymer of the present invention may further comprise monomers other than the monomers of the formula (1) and formula (2). As examples, styrene, a-methylstyrene, 4-methylstyrene, 2-methylstyrene, 3-methylstyrene, isobornyl acrylate, tricyclodecanyl (meth) acrylate, tetracyclododecenyl (meth) acrylate, and the like can be given. Of these, styrene, α-methylstyrene, 4-methylstyrene, 2-methylstyrene, 3-methylstyrene, and tricyclodecanyl acrylate are preferable, and styrene is particularly preferable.

Taking the balance of the resolution and dry etching resistance into consideration, the proportion of such monomers is usually 20 mol % or less.

As the method for copolymerizing monomers including the monomers of the formula (1) and (2), anionic polymerization is preferable due to easy control of the copolymer structure.

The anionic polymerization can be carried out as follows, for example. The monomers are stirred in a suitable organic solvent in the presence of an anionic polymerization initiator in a nitrogen atmosphere while maintaining the temperature at −100° C. to 120° C. for 0.5 to 24 hours, for example.

As the solvent, any hydrocarbon solvents or polar solvents may be used. As examples of the hydrocarbon solvent, pentane, hexane, heptane, octane, methylcyclopentane, cyclohexane, benzene, toluene, and xylene can be given.

In the polymerization using a hydrocarbon solvent, ether compounds such as diethyl ether, di-n-butyl ether, ethylene glycol diethyl ether, ethylene glycol dibutyl ether, ethylene glycol dimethyl ether, propylene glycol dimethyl ether, propylene glycol diethyl ether, propylene glycol dibutyl ether, tetrahydrofuran, 2,2-(bistetrahydrofurfuryl)propane, bistetrahydrofurfurylformal, methyl ether of bistetrahydrofurfuryl alcohol, ethyl ether of bistetrahydrofurfuryl alcohol, butyl ether of bistetrahydrofurfuryl alcohol, α-methoxytetrahydrofuran, dimethoxybenzene, and dimethoxyethane and/or tertiary amine compounds such as triethylamine, pyridine, N,N,N′,N′-tetramethyl ethylenediamine, dipiperidinoethane, methyl ether of N,N-diethylethanolamine, ethyl ether of N,N-diethylethanolamine, and butyl ether of N,N-diethylethanolamine may be added, as appropriate.

As examples of the polar solvent, ether compounds such as diethyl ether, tetrahydrofuran, dioxane, and trioxane, tertiary amines such as tetramethylethylenediamine (TMEDA) and hexamethylphosphoric triamide (HMPA), and the like can be given.

These hydrocarbon solvents and polar solvents may be used either individually or in combination of two or more.

As the anionic polymerization initiator, an organic alkali metal such as n-butyllithium, s-butyllithium, t-butyllithium, ethyllithium, ethylsodium, phenyllithium, lithium naphthalene, sodium naphthalene, potassium naphthalene, lithium stilbene, 1,1-diphenylhexyllithium, 1,1-diphenyl-3-methylpentyllithium, and the like can be used.

After the copolymerization, the side chains of the monomer of the formula (1) are hydrolyzed completely and those of the formula (2) are hydrolyzed partially to produce the copolymer containing a recurring unit having a phenolic hydroxyl group on the side chains.

Preferably, after the copolymerization, the monomer of the formula (2) may be hydrolyzed exceed 60 mol %, thus, 40 mol % or less side chains of the monomer of the formula (2) may be allowed to remain.

A method and conditions for selectively hydrolyzing the side chain of the monomer of the formula (1) and the formula (2) will now be explained.

An acid catalyst is used in the hydrolysis reaction. As examples of the acid catalyst used in the hydrolysis reaction, hydrochloric acid and sulfuric acid, as well as organic acids such as p-toluenesulfonic acid and its hydrate, methanesulfonic acid, trifluoromethanesulfonic acid, malonic acid, oxalic acid, 1,1,1-trifluoroacetic acid, acetic acid, p-toluenesulfonic acid pyridinium salt, and the like can be given.

As examples of suitable organic solvents used in the hydrolysis reaction, ketones such as acetone, methyl ethyl ketone, and methyl amyl ketone; ethers such as diethyl ether and tetrahydrofuran (THF); alcohols such as methanol, ethanol, and propanol; aliphatic hydrocarbons such as hexane, heptane, and octane; aromatic hydrocarbons such as benzene, toluene, and xylene; alkyl halides such as chloroform, bromoform, methylene chloride, methylene bromide, and carbon tetrachloride; esters such as ethyl acetate, butyl acetate, ethyl lactate, propylene glycol monomethyl ether, propylene glycol monomethyl ether acetate, and cellosolve; aprotic polar solvent such as dimethylformamide, dimethyl sulfoxide, hexamethylphosphoroamide, and the like can be given. Of these, acetone, methyl amyl ketone, methyl ethyl ketone, tetrahydrofuran, methanol, ethanol, propanol, ethyl acetate, butyl acetate, ethyl lactate, propylene glycol monomethyl ether, propylene glycol monomethyl ether acetate, and the like are particularly preferable.

The hydrolysis conditions to be hydrolyzed completely the side chain of the monomer moiety shown by the formula(1) and to be hydrolyzed partially the side chain of the monomer moiety shown by the formula(2) in the copolymer include the concentration of 1 to 50 wt %, preferably 3 to 40 wt %, and more preferably 5 to 30 wt %; the temperature of −20 to 80° C., preferably 0 to 60° C., and more preferably 5 to 40° C., and the reaction time, which may vary according to the temperature, is in the range from 10 minutes to 20 hours, preferably 30 minutes to 10 hours, and more preferably 1 to 6 hours. The molecular weight of the copolymer obtained by the hydrolysis at room temperature becomes larger than that of hydrolysis at around 50° C.

The hydrolysis reaction is carried out by dissolving the copolymer in an organic solvent, adding an acid catalyst, and stirring the mixture.

The proportion of the recurring unit having a phenolic hydroxyl group on the side chain in the copolymer prepared by the hydrolysis reaction is usually 40-90 mol %, preferably 50-85 mol %, and more preferably 60-80 mol %.

The proportion of the recurring unit derived from the monomer of the formula(2) is usually 5-50 mol %, preferably 10-50 mol %, and more preferably 15-50 mol %.

The above proportion of recurring units not only ensures improved resolution, sensitivity, and exposure latitude, but also excels in pattern collapse margin in resist pattern formation.

The polystyrene-reduced weight average molecular weight (hereinafter referred to as “Mw”) of the copolymer determined by gel permeation chromatography (GPC) is less than 12,000, preferably 3,000 to 11,500, more preferably 3,500 to 9,500, and particularly preferably 4,000 to 9,000. The ratio of Mw to the polystyrene-reduced number average molecular weight measured by GPC (hereinafter referred to as “Mn”) (Mw/Mn) is usually 1 to 5.

In the case that the coating was exposed by electron beams or (extreme) far ultraviolet rays such as EUV, the Mw of the copolymer is not less than 500 and not more than 2,000, the copolymer is preferable because of excelling in the pattern forming and suppressing the nano-edge roughness.

The reason for that the lower molecular weight makes the copolymer excelling in the pattern forming and suppressing the nano-edge roughness is; (1) The lower the molecular weight, the shorter the chain of polymer consisted of the resin. As a result, the grain size, which tangled the polymer becomes smaller and suppresses the nano-edge roughness. (2) Sec-butyllithium or n-butyllithium is used as an polymerization initiator, for example, the lower the molecular weight, more significant effects of the terminal of the polymer having hydrophobicity. As a result, a rectangular resist pattern may be obtained due to increase the contrast between the exposed and unexposed area.

As the photoacid generator (hereinafter referred to as “acid generator”) generating an acid upon exposure to light, (1) sulfonimide compounds, (2) disulfonylmethane compounds, (3) onium salt compounds, (4) sulfone compounds, (5) sulfonic acid ester compounds, (6) diazomethane compounds, and the like can be given.

The example of the acid generator is described below.

(1) Sulfonimide Compound

As an example of the sulfonimide compound, a compound of the following formula (3) can be given. 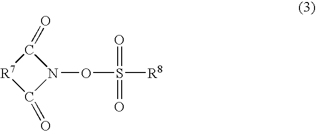
wherein R⁸ is a monovalent organic group and R⁷ is a divalent organic group.

As the monovalent organic group, a substituted or unsubstituted linear or branched alkyl group, substituted or unsubstituted cyclic alkyl group, substituted or unsubstituted aryl group, perfluoroalkyl group, and the like can be given. As the divalent organic group, a substituted or unsubstituted alkylene group, substituted or unsubstituted alkenylene group, substituted or unsubstituted phenylene group, and the like can be given.

As specific examples of the sulfonimide compound,
N-(trifluoromethylsulfonyloxy) succinimide,
N-(trifluoromethylsulfonyloxy)bicyclo[2.2.1]hept-5-ene-2,3-dicarboxyimide,
N-(10-camphorsulfonyloxy) succinimide,
N-(10-camphorsulfonyloxy)bicyclo[2.2.1]hept-5-ene-2,3-dicarboxyimide,
N-(10-camphorsulfonyloxy)-7-oxabicyclo[2.2.1]hept-5-ene-2,3-dicarboxyimide,
N-(4-methylphenylsulfonyloxy) succinimide,
N-(4-methylphenylfonyloxy)bicyclo[2.2.1]hept-5-ene-2,3-dicarboxyimide,
N-(4-trifluoromethylphenylsulfonyloxy)succinimide,
N-(4-trifluoromethylphenylsulfonyloxy) bicyclo[2.2.1]hept-5-ene-2,3-dicarboxyimide,
N-(perfluorophenylsulfonyloxy)succinimide,
N-(perfluorophenylsulfonyloxy)bicyclo[2.2.1]hept-5-ene-2,3-dicarboxyimide,
N-(nonafluorobutylsulfonyloxy)succinimide,
N-(nonafluorobutylsulfonyloxy)bicyclo[2.2.1]hept-5-ene-2,3-dicarboxyimide,
N-(perfluorooctylsulfonyloxy)succinimide,
N-(perfluorooctylsulfonyloxy)bicyclo[2.2.1]hept-5-ene-2,3-dicarboxyimide,
N-(phenylsulfonyloxy)succinimide,
N-(phenylsulfonyloxy)bicyclo[2.2.1]hept-5-ene-2,3-dicarboxyimide,
N-(phenylsulfonyloxy)-7-oxabicyclo[2.2.1]hept-5-ene-2,3-dicarboxyimide,
N-{(5-methyl-5-carboxymethane bicyclo[2.2.1]hepta-2-yl) sulfonyloxy}succinimide, and the like can be given.

Of these sulfonimide compounds,
N-(trifluoromethylsulfonyloxy)bicyclo[2.2.1]hept-5-ene-2,3-dicarboxyimide,
N-(10-camphorsulfonyloxy) succinimide, N-(4-methylphenylsulfonyloxy) succinimide,
N-(nonafluorobutylsulfonyloxy)bicyclo[2.2.1]hept-5-ene-2,3-dicarboxyimide,
N-(phenylsulfonyloxy)bicyclo[2.2.1]hept-5-ene-2,3-dicarboxyimide,
N-{(5-methyl-5-carboxymethyl bicyclo[2.2.1]hepta-2-yl) sulfonyloxy) succinimide are preferable.
   (2) Disulfonylmethane Compound

As an example of the disulfonylmethane compound, a compound of the following formula (4) can be given. 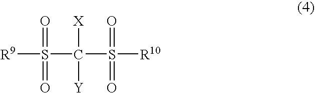
wherein R⁹ and R¹⁰ individually represent a linear or branched aliphatic hydrocarbon group, a cycloalkyl group, an aryl group, an aralkyl group, and a monovalent other organic group having a hetero atom, X and Y individually represent an aryl group, a hydrogen atom, a linear or branched monovalent aliphatic hydrocarbon group, and a monovalent other organic group having a hetero atom, at least one of X and Y represents an aryl group, or X and Y bond together to form a monocyclic or polycyclic carbon ring having a unsaturated bond, or X and Y bond together to form a group of the following formula (4-1). 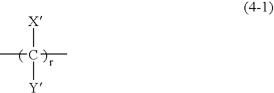
wherein X′ and Y′ individually represent a hydrogen atom, a halogen atom, a linear or branched alkyl group, cycloalkyl group, an aryl group, and an aralkyl group, or X′ and Y′, each bonding to the same or different carbon atom, bond together to form a monocyclic carbon ring, one or more X′ and Y′ individually represent same or different, and r represents an integer of 2-10.
(3) Onium Salt Compound

As the onium salt compound, for example, iodonium salt, sulfonium salt, phosphonium salt, diazonium salt, ammonium salt, pyridinium salt, and the like can be given.

As specific examples of the onium salt compound, bis(4-t-butylphenyl)iodonium nonafluorobutanesulfonate, bis(4-t-butylphenyl)iodonium trifluoromethanesulfonate, bis(4-t-butylphenyl)iodonium perfluorooctanesulfonate, bis(4-t-butylphenyl)iodonium p-toluenesulfonate, bis(4-t-butylphenyl)iodonium 10-camphorsulfonate, bis(4-t-butylphenyl)iodonium 4-trifluoromethylbenzenesulfonate, bis(4-t-butylphenyl)iodonium perfluorobenzenesulfonate, diphenyliodonium nonafluorobutanesulfonate, diphenyliodonium trifluoromethanesulfonate, diphenyliodonium perfluorooctanesulfonate, diphenyliodonium p-toluenesulfonate, diphenyliodonium benzenesulfonate, diphenyliodonium 10-camphorsulfonate, diphenyliodonium 4-trifluoromethylbenzenesulfonate, diphenyliodonium perfluorobenzenesulfonate, triphenylsulfonium nonafluorobutanesulfonate, triphenylsulfonium trifluoromethanesulfonate, triphenylsulfonium perfluorooctanesulfonate, triphenylsulfonium p-toluenesulfonate, triphenylsulfonium benzenesulfonate, triphenylsulfonium 10-camphorsulfonate, triphenylsulfonium 4-trifluoromethylbenzenesulfonate, triphenylsulfonium perfluorobenzenesulfonate, 4-hydroxyphenyl diphenylsulfonium trifluoromethanesulfonate, tris(p-methoxyphenyl)sulfonium nonafluorobutanesulfonate, tris(p-methoxyphenyl)sulfonium trifluoromethanesulfonate, tris(p-methoxyphenyl)sulfonium perfluorooctanesulfonate, tris(p-methoxyphenyl)sulfonium p-toluenesulfonate, tris(p-methoxyphenyl)sulfonium benzenesulfonate, tris(p-methoxyphenyl)sulfonium 10-camphorsulfonate, bis(p-fluorophenyl)iodonium trifluoromethanesulfonate, bis(p-fluorophenyl)iodonium nonafluoromethanesulfonate, bis(p-fluorophenyl)iodonium 10-camphorsulfonate, (p-fluorophenyl)(phenyl)iodonium trifluoromethanesulfonate, tris(p-fluorophenyl)sulfonium trifluoromethanesulfonate, tris(p-fluorophenyl)sulfonium p-toluenesulfonate, (p-fluorophenyl)diphenylsulfonium trifluoromethanesulfonate, 2,4,6-trimethylphenyl diphenylsulfonium 2,4-difluorobenzenesulfonate, 2,4,6-trimethylphenyl diphenylsulfonium 4-trifluoromethylbenzenesulfonate, and the like can be given.

(4) Sulfone Compound

As an example of the sulfone compound, β-ketosulfone, β-sulfonylsulfone, and α-diazo compounds of these compounds, and the like can be given.

As specific examples of the sulfone compound, phenacylphenylsulfone, mesitylphenylsulfone, bis (phenylsulfonyl) methane, 4-trisphenacylsulfone, and the like can be given.

(5) Sulfonic Acid Ester Compound

As an example of the sulfonic acid ester compound, alkyl sulfonic acid ester, haloalkyl sulfonic acid ester, aryl sulfonic acid ester, imino sulfonate, and the like can be given.

As specific examples of the sulfonic acid ester compound, benzointosylate, pyrogallol tris(trifluoromethanesulfonate), pyrogallol tris(nonafluoro-n-butanesulfonate), pyrogallol tris(methanesulfonate), nitrobenzyl-9,10-diethoxyanthracene-2-sulfonate, α-methylolbenzointosylate, α-methylolbenzoin n-octanesulfonate, α-methylol benzoin trifluoromethanesulfonate, α-methylolbenzoin n-dodecanesulfonate, and the like can be given.

(6) Diazomethane Compound

As an example of the diazomethane compound, a compound of the following formula (5) can be given. 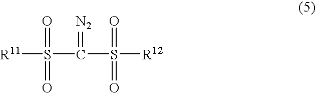
wherein R¹¹ and R¹² is individually represent monovalent group such as an alkyl group, an aryl group, a halogenated alkyl group, a halogenated aryl group, and the like.

As specific examples of the diazomethane compound, bis(trifluoromethylsulfonyl) diazomethane, bis(cyclohexylsulfonyl) diazomethane, bis(phenylsulfonyl) diazomethane, bis(4-methylphenylsulfonyl) diazomethane, methylsulfonyl-4-methylphenylsulfonyl diazomethane, cyclohexylsulfonyl-1,1-dimethylethylsulfonyl diazomethane, bis(1,1-dimethylethylsulfonyl) diazomethane, bis(3,3-dimethyl-1,5-dioxaspiro[5,5]dodecane-8-sulfonyl) diazomethane, bis(1,4-dioxaspiro [4,5]decane-7-sulfonyl) diazomethane, bis(t-butylsulfonyl) diazomethane, and the like can be given.

As specific examples of the preferable acid generator, sulfonimide compounds such as N-(trifluoromethylsulfonyloxy)succinimide, N-(trifluoromethylsulfonyloxy) bicyclo[2.2.1]hept-5-ene-2,3-dicarboxyimide, N-(10-camphorsulfonyloxy) succinimide, N-(10-camphorsulfonyloxy)bicyclo[2.2.1]hept-5-ene-2,3-dicarboxyimide, N-{(5-methyl-5-carboxymethyl bicyclo[2.2.1]hepta-2-yl) sulfonyloxy} succinimide, N-(nonafluorobutylsulfonyloxy) bicyclo[2.2.1]hept-5-ene-2,3-dicarboxyimide, N-(4-methylphenyl sulfonyloxy) succinimide, and N-(phenylsulfonyloxy)bicyclo[2.2.1]hept-5-ene-2,3-dicarboxyimide; onium salts such as bis(4-t-butylphenyl)iodonium trifluoromethane sulfonate, bis(4-t-butylphenyl)iodonium perfluoro-n-butanesulfonate, bis(4-t-butylphenyl)iodonium p-toluenesulfonate, bis(4-t-butylphenyl)iodonium 10-camphorsulfonate, bis(4-t-butylphenyl)iodonium 2-trifluoromethylbenzenesulfonate, bis(4-t-butylphenyl)iodonium 4-trifluoromethylbenzenesulfonate, bis(4-t-butylphenyl)iodonium 2,4-difluorobenzenesulfonate, triphenylsulfonium trifluoromethanesulfonate, triphenylsulfonium perfluoro-n-butanesulfonate, triphenylsulfonium p-toluenesulfonate, triphenylsulfonium 10-camphorsulfonate, triphenylsulfonium 2-trifluoromethylbenzenesulfonate, triphenylsulfonium 4-trifluorobenzenesulfonate, triphenylsulfonium 2,4-difluoromethylbenzenesulfonate, bis(4-t-butylphenyl)iodonium perfluorooctanesulfonate, diphenyliodonium nonafluorobutanesulfonate, diphenyliodonium trifluoromethanesulfonate, diphenyliodonium perfluorooctanesulfonate, diphenyliodonium 10-camphorsulfonate, triphenylsulfonium perfluorooctanesulfonate, tris(p-methoxyphenyl)sulfonium trifluoromethanesulfonate, tris(p-methoxyphenyl)sulfonium 10-camphorsulfonate, bis(p-fluorophenyl)iodonium trifluoromethanesulfonate, bis(p-fluorophenyl)iodonium nonafluoromethanesulfonate, bis(p-fluorophenyl)iodonium 10-camphorsulfonate, (p-fluorophenyl)(phenyl)iodonium trifluoromethanesulfonate, tris(p-fluorophenyl)sulfonium trifluoromethanesulfonate, tris(p-fluorophenyl)sulfonium p-toluenesulfonate, (p-fluorophenyl)diphenylsulfonium trifluoromethanesulfonate, 2,4,6-trimethylphenyl diphenylsulfonium 2,4-difluorobenzenesulfonate, and 2,4,6-trimethylphenyl diphenylsulfonium 4-trifluoromethylbenzenesulfonate; diazomethane compounds such as bis(cyclohexylsulfonyl) diazomethane, bis(3,3-dimethyl-1,5-dioxaspiro [5,5]dodecane-8-sulfonyl) diazomethane, bis(1,4-dioxaspiro [4,5]decane-7-sulfonyl) diazomethane, and bis(t-butylsulfonyl) diazomethane; can be given. These acid generators may be used at least one of the acid generators selected from above.

In the present invention, the amount of acid generator to be used is usually from 0.1 to 20 parts by weight, and preferably from 0.5 to 15 parts by weight for 100 parts by weight of the resin. The acid generators can be used in combination of two or more.

It is preferable to add alkali-soluble resins, acid diffusion controllers, and other additives to the radiation-sensitive resin composition of the present invention.

Examples of the alkali-soluble resin include poly(p-hydroxystyrene), partially hydrogenated poly(p-hydroxystyrene), poly(m-hydroxystyrene), poly(m-hydroxystyrene), (p-hydroxystyrene)-(m-hydroxystyrene) copolymer, (p-hydroxystyrene)-(styrene) copolymer, novolac resin, polyvinyl alcohol, polyacrylic acid, and the like. The Mw of the resin is from 1,000 to 1,000,000, preferably from 2,000 to 100,000. The alkali-soluble resins can be used either individually or in combinations of two or more.

The amount of the alkali-soluble resin to be added is usually 30 parts by weight or less for 100 parts by weight of the resin.

The acid diffusion controllers control diff-usion of an acid generated from the acid generator upon exposure in the resist film to suppress undesired chemical reactions in the unexposed area. Addition of the acid diffusion controller fuirther improves storage stability of the resulting composition and resolution of the resist. Moreover, the addition of the acid diffusion controller prevents the line width of the resist pattern from changing due to changes in the post-exposure delay (PED), whereby a composition with remarkably superior process stability can be obtained.

As the acid diffusion controller, nitrogen-containing organic compounds of which the basicity does not change during exposure or heating when forming a resist pattern are preferable.

As examples of the nitrogen-containing organic compound, a compound of the following formula (6) (hereinafter referred to as “nitrogen-containing compound (I)”), a diamino compound having two nitrogen atoms in the molecule (hereinafter referred to as “nitrogen-containing compound (II)”), a diamino polymer having three or more nitrogen atoms (hereinafter referred to as “nitrogen-containing compound (III)”), amide group-containing compounds, urea compounds, and nitrogen-containing heterocyclic compounds can be given. 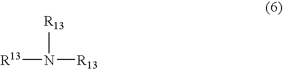
wherein R¹³ individually represent same or different, a hydrogen atom, an alkyl group, an aryl group, and aralkyl group, which may be substituted by functional group such as a hydroxyl group, for a hydrogen atom of the alkyl group, the aryl group, and the aralkyl group.

As examples of the nitrogen-containing compound (I), monoalkylamines such as n-hexylamine, n-heptylamine, n-octylamine, n-nonylamine, and n-decylamine; dialkylamines such as di-n-butylamine, di-n-pentylamine, di-n-hexylamine, di-n-heptylamine, di-n-octylamine, di-n-nonylamine, and di-n-decylamine; trialkylamines such as triethylamine, tri-n-propylamine, tri-n-butylamine, tri-n-pentylamine, tri-n-hexylamine, tri-n-heptylamine, tri-n-octylamine, tri-n-nonylamine, and tri-n-decylamine; aromatic amines such as aniline, N-methylaniline, N,N-dimethylaniline, 2-methylaniline, 3-methylaniline, 4-methylaniline, 4-nitroaniline, diphenylamine, triphenylamine, and 1-naphthylamine; and the like can be given.

As examples of the nitrogen-containing compound (II), ethylenediamine, N,N,N′,N′-tetramethylethylenediamine, N,N,N′,N′-tetrakis(2-hydroxypropyl)ethylenediamine, tetramethylenediamine, hexamethylenediamine, 4,4′-diaminodiphenylmethane, 4,4′-diaminodiphenyl ether, 4,4′-diaminobenzophenone, 4,4′-diaminodiphenylamine, 2,2′-bis(4-aminophenyl)propane, 2-(3-aminophenyl)-2-(4-aminophenyl) propane, 2-(4-aminophenyl)-2-(3-hydroxylphenyl) propane, 2-(4-aminophenyl)-2-(4-hydroxylphenyl)propane, 1,4-bis[1-(4-aminophenyl)-1-methylethyl]benzene, 1,3-bis[1-(4-aminophenyl)-1-methylethyl]benzene, and the like can be given.

As examples of the nitrogen-containing compound (III), polyethyleneimine, polyallylamine, polymer of dimethylaminoethyl acrylamide, and the like can be given.

As examples of the amide group-containing compounds, formamide, N-methylformamide, N,N-dimethylformamide, acetamide, N-methylacetamide, N,N-dimethylacetamide, propionamide, benzamide, pyrrolidone, N-methylpyrrolidone, and the like can be given.

As examples of the urea compounds, urea, methylurea, 1,1-dimethylurea, 1,3-dimethylurea, 1,1,3,3-tetramethylurea, 1,3-diphenylurea, tributylthiourea, and the like can be given.

As examples of the nitrogen-containing heterocyclic compounds, imidazoles such as imidazole, benzimidazole, 4-methylimidazole, 4-methyl-2-phenylimidazole, and 2-phenylbenzimidazole; pyridines such as pyridine, 2-methylpyridine, 4-methylpyridine, 2-ethylpyridine, 4-ethylpyridine, 2-phenylpyridine, 4-phenylpyridine, N-methyl-4-phenylpyridine, nicotine, nicotinic acid, nicotinamide, quinoline, 8-oxyquinoline, and acridine; and pyrazine, pyrazole, pyridazine, quinoxaline, purine, pyrrolidine, piperidine, morpholine, 4-methylmorpholine, piperazine, 1,4-dimethylpiperazine, and 1,4-diazabicyclo[2.2.2]octane, and the like can be given.

Base precursor having acid-labile group may be added as acid diffusion controller. Examples of the base precursors, N-(t-butoxycarbonyl) piperidine, N-(t-butoxycarbonyl) imidazole, N-(t-butoxycarbonyl) benzimidazole, N-(t-butoxycarbonyl) 2-phenylbenzimidazole, N-(t-butoxycarbonyl) dioctylamine, N-(t-butoxycarbonyl) diethanolamine, N-(t-butoxycarbonyl) dicyclohexylamine, N-(t-butoxycarbonyl) diphenylamine, and the like can be given.

Of these nitrogen-containing organic compounds, the nitrogen-containing compounds (I) and nitrogen-containing heterocyclic compounds are preferable. Among the nitrogen-containing compounds (I), trialkylamines are particularly preferable. Among the nitrogen-containing heterocyclic compounds, imidazoles are particularly preferable.

The acid diffusion controller can be used either individually or in combination of two or more.

The amounts of the acid diffusion controller to be added is usually 15 parts by weight or less, preferably 0.001 to 10 parts by weight, and still more preferably 0.005 to 5 parts by weight for 100 parts by weight of the resin. If the amount of the acid diffusion controller exceeds 15 parts by weight, sensitivity as a resist and developability of the exposed area tend to decrease. If the amount is less than 0.001 parts by weight, the pattern profile or dimensional accuracy as a resist may decrease depending on the processing conditions.

Surfactants exhibiting an action of improving the applicability or striation of the composition and developability as resist may optionally be added to the radiation-sensitive resin composition of the present invention.

As examples of the surfactant, polyoxyethylene lauryl ether, polyoxyethylene stearyl ether, polyoxyethylene oleyl ether, polyoxyethylene octyl phenol ether, polyoxyethylene nonyl phenol ether, polyethylene glycol dilaurate, polyethylene glycol distearate, and commercially available products such as FTOP EF301, EF303, EF352 (manufactured by Tohkem Products Corporation), MEGAFAC F 171, F 173 (manufactured by Dainippon Ink and Chemicals, Inc.), Fluorad FC430, FC431 (manufactured by Sumitomo 3M Ltd.), Asahi Guard AG710, and Surflon S-382, SC-101, SC-102, SC-103, SC-104, SC-105, SC-106 (manufactured by Asahi Glass Co., Ltd.), KP341 (manufactured by Shin-Etsu Chemical Co., Ltd.), and POLYFLOW No. 75, No. 95 (manufactured by Kyoeisha Chemical Co., Ltd.) can be given.

The amount of surfactants to be added is usually two parts by weight or less for 100 parts by weight of the acid-labile group-containing resin.

Other sensitizers may optionally be added to the radiation-sensitive resin composition of the present invention. As preferable examples of sensitizers, carbazoles, benzophenones, rose bengals, and anthracenes can be given.

The amount of sensitizers to be added is preferably 50 parts by weight or less for 100 parts by weight of the resin.

In addition, a dye and/or a pigment may be added to visualize latent image of exposed area and to reduce the effects of halation during exposure. Addition of the adhesion promoters further improves adhesion to the substrate.

As examples of other additives, halation inhibitors such as 4-hydroxy-4′-methylchalcone, form improvers, storage stabilizers, anti-foaming agents, and the like can be given.

When using, the radiation-sensitive resin composition of the present invention is made into a composition solution by dissolving the composition in a solvent so that the total solid content is usually from 0.1 to 50 wt %, and preferably from 1 to 40 wt %, and filtering the solution using a filter with a pore diameter of about 200nm, for example.

As examples of solvents used for preparation of the composition solution, ethylene glycol monoalkyl ether acetates such as ethylene glycol monomethyl ether acetate, ethylene glycol monoethyl ether acetate, ethylene glycol mono-n-propyl ether acetate, and ethylene glycol mono-n-butyl ether acetate; propylene glycol monoalkyl ethers such as propylene glycol monomethyl ether, propylene glycol monoethyl ether, propylene glycol mono-n-propyl ether, and propylene glycol mono-n-butyl ether; propylene glycol dialkyl ethers such as propylene glycol dimethyl ether, propylene glycol diethyl ether, propylene glycol di-n-propyl ether, and propylene glycol di-n-butyl ether; propylene glycol monoalkyl ether acetates such as propylene glycol monomethyl ether acetate, propylene glycol monoethyl ether acetate, propylene glycol mono-n-propyl ether acetate, and propylene glycol mono-n-butyl ether acetate; lactic acid esters such as methyl lactate, ethyl lactate, n-propyl lactate, and i-propyl lactate; aliphatic carboxylic acid esters such as n-amyl formate, i-amyl formate, ethyl acetate, n-propyl acetate, i-propyl acetate, n-butyl acetate, i-butyl acetate, n-amyl acetate, i-amyl acetate, i-propyl propionate, n-butyl propionate, and i-butyl propionate; other esters such as ethyl hydroxyacetate, ethyl 2-hydroxy-2-methylpropionate, methyl 2-hydroxy-3-methylbutyrate, ethyl methoxyacetate, ethyl ethoxyacetate, methyl 3-methoxypropionate, ethyl 3-methoxypropionate, methyl 3-ethoxypropionate, ethyl 3-ethoxypropionate, butyl 3-methoxyacetate, butyl 3-methyl-3-methoxyacetate, butyl 3-methyl-3-methoxypropionate, butyl 3-methyl-3-methoxybutylate, methyl acetoacetate, ethyl acetoacetate, methyl pyruvate, and ethyl pyruvate; aromatic hydrocarbons such as toluene, and xylene; ketones such as methyl ethyl ketone, methyl propyl ketone, methyl butyl ketone, 2-heptanone, 3-heptanone, 4-heptanone, and cyclohexanone; amides such as N-methylformamide, N,N-dimethylformamide, N-methylacetamide, N,N-dimethylacetamide, and N-methylpyrrolidone; lactones such as r -butyrolactone, and the like can be given.

These solvents may be used either individually or in combination of two or more.

A resist pattern is formed from the radiation-sensitive resin composition of the present invention by applying the composition solution prepared as mentioned above to substrates such as a silicon wafer and a wafer coated with aluminum using an appropriate application method such as spin coating, cast coating, and roll coating to form a resist film. The resist film is then optionally pre-baked (hereinafter called “PB”) with temperature about 70° C. to 160° C. and exposed with radiation through a specific mask pattern. As the radiation, deep ultraviolet rays such as F₂ excimer laser (wavelength: 157 nm), ArF excimer laser (wavelength: 193 nm), and KrF excimer laser (wavelength: 248 nm), X-rays such as synchrotron radiation, or charged particle rays such as electron beams may be appropriately selected according to the types of acid generator. The exposure conditions such as exposure dosage are appropriately determined depending on the composition of the radiation-sensitive resin composition, types of additives, and the like. Of these, deep ultraviolet rays such as KrF excimer laser (wavelength: 248 nm) or the like, X-rays such as synchrotron radiation, or charged particle rays such as electron beams are preferable.

It is preferable in the present invention to perform post exposure bake (PEB) with temperature at 70° C. to 160° C. for 30 seconds or more in order to stably form a highly-accurate minute pattern. If the temperature of the PEB is less than 70° C., sensitivity may fluctuate according to the type of substrates.

Then, the resist film was developed under the conditions at 10° C. to 50° C. for 10 to 200 seconds, preferably at 15° C. to 30° C. for 15 to 100 seconds, and more preferably at 20° C. to 25° C. for 15 to 90 seconds in an alkaline developer to form a specific resist pattern.

As the alkaline developer, an alkaline aqueous solution prepared by dissolving an alkali compound such as tetraalkyl ammonium hydroxides to a concentration of 1 to 10 wt %, preferably 1 to 5 wt %, and particularly preferably 1 to 3 wt %, for example, may be usually used.

A water-soluble organic solvent such as methanol, ethanol or the like, or a surfactant may be appropriately added to the developer such as the alkaline aqueous solution. When forming a resist pattern, a protection film may be provided on the resist film in order to prevent the effects of basic impurities and the like in an environmental atmosphere.

### EXAMPLES

### Example 1

A solvent refluxed for six hours in the presence of sodium metal and after that distilled under nitrogen atmosphere was used. Monomers were used after bubbling dry nitrogen for one hour, followed by distillation. 37.6 g of p-(1-ethoxy) ethoxystyrene, 11.0 g of p-t-butoxystyrene, and 1.4 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 5.92 ml of n-butyllithium (1.83 mol/l cyclohexane solution) and 1.96 g of N,N,N′,N′-tetramethylethylenediamine were added in this order. The mixture was reacted for one hour while maintaining the temperature at −20° C. Then, 2.0 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred at 50° C. for 15 minutes to be hydrolyzed. The resulting copolymer solution was added dropwise to a large quantity of water to coagulate the copolymer. The produced white powder was filtered and dried overnight at 50° C. under reduced pressure.

The copolymer was found to have Mw and Mw/Mn of 8,000 and 1.1 respectively. The result of ¹³C-NMR analysis confirmed that the copolymerization molar ratio of p-hydroxystyrene, styrene, and p-t-butoxystyrene of the copolymer was 75:5:20. The ratio means that the whole p-(1-ethoxy) ethoxystyrene moiety and 3 mol % of p-t-butoxystyrene moiety were converted into p-hydroxystyrene recurring units, respectively. This copolymer is referred to as “acid-labile group-containing resin (A-1)”.

The Mw and Mn of the copolymer (A-1) and the polymers prepared in the following Examples were measured by gel permeation chromatography (GPC) using GPC columns (manufactured by Tosoh Corp., G2000H_{XL}×2, G3000H_{XL}×1, G4000H_{XL}×1) under the following conditions. Flow rate: 1.0 ml/minute, eluate: tetrahydrofuran, column temperature: 40° C., standard reference material: monodispersed polystyrene

### Example 2

The copolymer was obtained in the same manner as in Example 1 with the exception of replacement 1.5 g of p-toluenesulfonic acid by 0.5 g of 35% hydrochloric acid aqueous solution. The Mw of the copolymer and molar ratio of the recurring unit are same as Example 1. This copolymer is referred to as “acid-labile group-containing resin (A-2)”.

### Example 3

The resins described below were prepared by the same manner as in Example 1 with the exception of changing the ratio of the monomers, the amounts of n-butyllithium and N,N,N′,N′-tetramethylethylenediamine. The acid-labile group-containing resin (A-7) is the example not containing styrene.

Acid-labile group-containing resin (A-3): The solution was charged by the following proportions; 35.2 g of p-(1-ethoxy) ethoxystyrene, 13.3 g of p-t-butoxystyrene, and 1.51 g of styrene. A catalyst for copolymerization was 5.92 ml of n-butyllithium (1.83 mol/l cyclohexane solution). The copolymer was found to have the copolymerization molar ratio of p-hydroxystyrene, styrene, and p-t-butoxystyrene of the copolymer was 72:5:23 (mol %), and Mw and Mw/Mn of 8,000 and 1.1 respectively.

Acid-labile group-containing resin (A-4): The solution was charged by the following proportions; 35.2 g of p-(1-ethoxy) ethoxystyrene, 13.3 g of p-t-butoxystyrene, and 1.51 g of styrene. A catalyst for copolymerization was 9.47 ml of n-butyllithium (1.83 mol/l cyclohexane solution). The copolymer was found to have the copolymerization molar ratio of p-hydroxystyrene, styrene, and p-t-butoxystyrene of the copolymer was 72:5:23 (mol %), and Mw and Mw/Mn of 5,000 and 1.1 respectively.

Acid-labile group-containing resin (A-5): The solution was charged by the following proportions; 35.2 g of p-(1-ethoxy) ethoxystyrene, 13.3 g of p-t-butoxystyrene, and 1.51 g of styrene. A catalyst for copolymerization was 4.44 ml of n-butyllithium (1.83 mol/l cyclohexane solution). The copolymer was found to have the copolymerization molar ratio of p-hydroxystyrene, styrene, and p-t-butoxystyrene of the copolymer was 72:5:23 (mol %), and Mw and Mw/Mn of 11,500 and 1.2 respectively.

Acid-labile group-containing resin (A-6): The solution was charged by the following proportions; 32.7 g of p-(1-ethoxy) ethoxystyrene, 15.8 g of p-t-butoxystyrene, and 1.51 g of styrene. A catalyst for copolymerization was 7.90 ml of n-butyllithium (1.83 mol/l cyclohexane solution). The copolymer was found to have the copolymerization molar ratio of p-hydroxystyrene, styrene, and p-t-butoxystyrene of the copolymer was 67:5:28 (mol %), and Mw and Mw/Mn of 6,000 and 1.1 respectively.

Acid-labile group-containing resin (A-7): The solution was charged by the following proportions; 32.5 g of p-(1-ethoxy) ethoxystyrene and 17.5 g of p-t-butoxystyrene. A catalyst for copolymerization was 7.90 ml of n-butyllithium (1.83 mol/l cyclohexane solution). The copolymer was found to have the copolymerization molar ratio of p-hydroxystyrene and p-t-butoxystyrene of the copolymer was 68:32 (mol %), and Mw and Mw/Mn of 6,000 and 1.1 respectively.

### Comparative Synthesis Example 1

101 g of p-acetoxystyrene, 5 g of styrene, 42 g of p-t-butoxystyrene, 6 g of azobisisobutyronitrile (AIBN), and 1 g of t-dodecyl mercaptan were dissolved in 160 g of propylene glycol monomethyl ether The mixture was copolymerized while maintaining the temperature at 60° C. for 16 hours under nitrogen atmosphere.

After the copolymerization, the resulting solution was added dropwise to a large quantity of hexane to coagulate the copolymer. Then, another 150 g of propylene glycol monomethyl ether was added to the copolymer. 300 g of methanol, 80 g of triethylamine, and 15 g of water were further added to the copolymer and hydrolized for 8 hours with refluxing at boiling point. After the hydrolysis reaction ended, the solvent and triethylamine were distilled under reduced pressure and the copolymer was dissolved in acetone. The resulting copolymer solution was added dropwise to a large quantity of water to coagulate the copolymer. The produced white powder was filtered and dried overnight at 50° C. under reduced pressure.

The copolymer was found to have Mw and Mw/Mn of 16,000 and 1.7 respectively. The result of ¹³C-NMR analysis confirmed that the copolymerization molar ratio of p-hydroxystyrene, styrene, and p-t-butoxystyrene of the copolymer was 72:5:23. This copolymer is referred to as “acid-labile group-containing resin (α-1)”.

### Comparative Synthesis Example 2

A solvent refluxed for six hours in the presence of sodium metal and after that distilled under nitrogen atmosphere was used. Monomers were used after bubbling dry nitrogen for one hour, followed by distillation. 37.6 g of p-(1-ethoxy) ethoxystyrene, 11.0 g of p-t-butoxystyrene, and 1.4 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 2.96 ml of n-butyllithium (1.83 mol/l cyclohexane solution) and 0.98 g of N,N,N′,N′-tetramethylethylenediamine were added in this order. The mixture was reacted for one hour while maintaining the temperature at −20° C. Then, 1.0 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred for three hours at room temperature (23-25° C.) to be hydrolyzed only p-(1-ethoxy) ethoxystyrene. The resulting copolymer solution was added dropwise to a large quantity of water to coagulate the copolymer. The produced white powder was filtered and dried overnight at 50° C. under reduced pressure.

The copolymer was found to have Mw and Mw/Mn of 16,000 and 1.3 respectively. The result of ¹³C-NMR analysis confirmed that the copolymerization molar ratio of p-hydroxystyrene, styrene, and p-t-butoxystyrene of the copolymer was 72:5:23. This copolymer is referred to as “acid-labile group-containing resin (α-2)”.

### Comparative Synthesis Example 3

A solvent refluxed for six hours in the presence of sodium metal and after that distilled under nitrogen atmosphere was used. Monomers were used after bubbling dry nitrogen for one hour, followed by distillation. 37.6 g of p-(1-ethoxy) ethoxystyrene, 11.0 g of p-t-butoxystyrene, and 1.4 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 4.44 ml of n-butyllithium (1.83 mol/l cyclohexane solution) and 1.47 g of N,N,N′,N′-tetramethylethylenediamine were added in this order. The mixture was reacted for one hour while maintaining the temperature at −20° C. Then, 1.5 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred for three hours at room temperature (23-25° C.) to be hydrolyzed only p-(1-ethoxy) ethoxystyrene. The resulting copolymer solution was added dropwise to a large quantity of water to coagulate the copolymer. The produced white powder was filtered and dried overnight at 50° C. under reduced pressure.

The copolymer was found to have Mw and Mw/Mn of 12,000 and 1.2 respectively. The result of ¹³C-NMR analysis confirmed that the copolymerization molar ratio of p-hydroxystyrene, styrene, and p-t-butoxystyrene of the copolymer was 72:5:23. This copolymer is referred to as “acid-labile group-containing resin (α-3)”.

### Comparative Synthesis Example 4

A solvent refluxed for six hours in the presence of sodium metal and after that distilled under nitrogen atmosphere was used. Monomers were used after bubbling dry nitrogen for one hour, followed by distillation. 37.6 g of p-(1-ethoxy) ethoxystyrene, 11.0 g of p-t-butoxystyrene, and 4.0 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 9.47 ml of n-butyllithium (1.83 mol/l cyclohexane solution) and 3.14 g of N,N,N′,N′-tetramethylethylenediamine were added in this order. The mixture was reacted for one hour while maintaining the temperature at −20° C. Then, 3.2 g of methanol was added to terminate the reaction.

After washing with 200 g of 3 wt % oxalic acid-water, 200 g of propylene glycol monomethyl ether and 1.5 g of p-toluenesulfonic acid were added. The mixture was stirred for three hours at room temperature (23-25° C.) to be hydrolyzed only p-(1-ethoxy) ethoxystyrene. The resulting copolymer solution was added dropwise to a large quantity of water to coagulate the copolymer. The produced white powder was filtered and dried overnight at 50° C. under reduced pressure.

The copolymer was found to have Mw and Mw/Mn of 5,000 and 1.1 respectively. The result of ¹³C-NMR analysis confirmed that the copolymerization molar ratio of p-hydroxystyrene, styrene, and p-t-butoxystyrene of the copolymer was 72:5:23. This copolymer is referred to as “acid-labile group-containing resin (α-4)”.

### Examples 4 to 13 and Comparative Examples 1 to 4

The composition solutions were prepared by mixing the components in proportions shown in Table 1 and filtered the solution using a membrane filter with a pore diameter of 200 nm. In the Table 1, “part” refers to “part by weight”. Then, the composition solutions were applied to a silicon wafer with a 60 nm thickness (“DUV42,” manufactured by Brewer Science Corp.) by spin coating. The silicon wafer was prepared by spin coating and baking with temperature at 205° C. for 60 seconds. After performing PB under the conditions shown in Table 2, a resist coating with a thickness of 400 nm was formed.

Then, the coating was exposed using a Stepper S203B (manufactured by Nikon Corp., lens numerical aperture: 0.68, σ0.75, ⅔ orbicular zone lightning) under the conditions shown in Table 2, and performed PEB under the conditions shown in Table 2. After performing PEB, the resist film was developed at 23° C. for one minute in a 2.38 wt % tetramethylammonium hydroxide aqueous solution by puddling, washed with water, and dried to form a resist pattern. The evaluation results of the resist are shown in Table 2.

Acid generators (B), acid diffusion controllers (C), and solvents (D) shown in Table 1 are described below.

Acid Generator (B):

(B-1): N-(trifluoromethylsulfonyloxy) bicyclo [2.2.1]hept-5-ene-2,3-dicarboxyimide

(B-2): Triphenylsulfonium trifluoromethanesulfonate

(B-3): Diphenyliodonium nonafluorobutanesulfonate

(B-4): Bis (4-t-butylphenyl) iodonium nonafluorobutanesulfonate

Acid Diffusion Controller (C):

(C-1): 2-phenylbenzimidazole

Solvent (D):

(D-1): Ethyl lactate

(D-2): Ethyl 3-ethoxypropionate

(D-3): Propylene glycol monomethyl ether acetate

Evaluation of resists was carried out as follows.

(1) Sensitivity:

A resist coating was formed on a silicon wafer, exposed to light, and immediately baked (PEB),.followed by alkali development, washing with water, and drying. Sensitivity was evaluated based on an optimum exposure dose capable of forming a 1:1 line-and-space pattern (1L1S) with a line width of 130 nm in each Example and Comparative Example.

(2) Pattern Collapse Margin:

In the line-and-space pattern (1L1S) with a line width of 130nm, the pattern collapse margin (J/m²) is characterized as the difference between the exposure dose occurred the pattern collapse and the optimum exposure dose.

(3) Exposure Latitude:

In the line-and-space pattern (1L1S) with a line width of 130 nm, the exposure latitude (J/m²) is characterized as the difference between the reduced exposure dose forming 10% narrow line width of 130 nm (namely 117 nm) and the optimum exposure dose.

TABLE 1

| | | | Acid | |
|---|---|---|---|---|
| | | Acid | diffusion | |
| | Resin (A) | generator (B) | controller (C) | Solvent (D) |
| | (part) | (part) | (part) | (part) |
| Example | | | | |
| 4 | A-1(100) | B-1(6) | C-1(0.4) | D-1(400) |
| | | | | D-3(400) |
| 5 | A-1(100) | B-1(6) | C-1(0.4) | D-1(400) |
| | | B-2(1) | | D-2(400) |
| 6 | A-1(100) | B-1(6) | C-1(0.4) | D-1(400) |
| | | B-3(1) | | D-2(400) |
| 7 | A-1(100) | B-4(3) | C-1(0.2) | D-1(400) |
| | | | | D-3(400) |
| 8 | A-2(100) | B-1(6) | C-1(0.4) | D-1(400) |
| | | | | D-3(400) |
| 9 | A-3(100) | B-1(6) | C-1(0.4) | D-1(400) |
| | | | | D-3(400) |
| 10 | A-4(100) | B-1(6) | C-1(0.4) | D-1(400) |
| | | | | D-3(400) |
| 11 | A-5(100) | B-1(6) | C-1(0.4) | D-1(400) |
| | | | | D-3(400) |
| 12 | A-6(100) | B-1(6) | C-1(0.4) | D-1(400) |
| | | | | D-3(400) |
| 13 | A-7(100) | B-1(6) | C-1(0.4) | D-1(400) |
| | | | | D-3(400) |
| Comparative | | | | |
| Example | | | | |
| 1 | α-1(100) | B-1(6) | C-1(0.4) | D-1(400) |
| | | | | D-3(400) |
| 2 | α-2(100) | B-1(6) | C-1(0.4) | D-1(400) |
| | | | | D-3(400) |
| 3 | α-3(100) | B-1(6) | C-1(0.4) | D-1(400) |
| | | | | D-3(400) |
| 4 | α-4(100) | B-1(6) | C-1(0.4) | D-1(400) |
| | | | | D-3(400) |

TABLE 2

| | | | | | | Pattern | |
|---|---|---|---|---|---|---|---|
| | PB | | PEB | | Sensitivity | collapse | Exposure |
| | (° C.) | (second) | (° C.) | (second) | (J/m²) | margin | latitude |
| Example | | | | | | | |
| 4 | 120 | 90 | 130 | 90 | 370 | 120 | 50 |
| 5 | 120 | 90 | 120 | 90 | 390 | 130 | 60 |
| 6 | 110 | 90 | 130 | 90 | 400 | 130 | 50 |
| 7 | 120 | 90 | 140 | 90 | 380 | 120 | 50 |
| 8 | 120 | 90 | 130 | 90 | 400 | 120 | 60 |
| 9 | 120 | 90 | 130 | 90 | 420 | 130 | 50 |
| 10 | 120 | 90 | 130 | 90 | 390 | 120 | 50 |
| 11 | 120 | 90 | 130 | 90 | 400 | 100 | 50 |
| 12 | 120 | 90 | 130 | 90 | 380 | 120 | 50 |
| 13 | 120 | 90 | 130 | 90 | 380 | 120 | 50 |
| Comparative Example | | | | | | | |
| 1 | 120 | 90 | 130 | 90 | 390 | 90 | 40 |
| 2 | 120 | 90 | 130 | 90 | 400 | 80 | 40 |
| 3 | 120 | 90 | 130 | 90 | 380 | 90 | 40 |
| 4 | 120 | 90 | 130 | 90 | 410 | 90 | 40 |

### Example 14

A solvent refluxed for six hours in the presence of sodium metal and after that distilled under nitrogen atmosphere was used. Monomers were used after bubbling dry nitrogen for one hour, followed by distillation. 29.1 g of p-(1-ethoxy) ethoxystyrene, 19.4 g of p-t-butoxystyrene, and 1.51 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 23.68 ml of n-butyllithium (1.83 mol/l cyclohexane solution) and 7.84 g of N,N,N′,N′-tetramethylethylenediamine were added in this order. The mixture was reacted for one hour while maintaining the temperature at −20° C. Then, 8.0 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred at 50° C. for 15 minutes to be hydrolyzed. The resulting copolymer solution was added dropwise to 2,000 g of water to coagulate the copolymer. The produced white powder was filtered and dried overnight at 50° C. under reduced pressure.

The copolymer was found to have Mw and Mw/Mn of 2,000 and 1.1 respectively. The result of ¹³C-NMR analysis confirmed that the copolymerization molar ratio of p-hydroxystyrene, styrene, and p-t-butoxystyrene of the copolymer was 60:5:35. The ratio means that the whole p-(1-ethoxy) ethoxystyrene moiety and 3 mol % of p-t-butoxystyrene moiety were converted into p-hydroxystyrene recurring units, respectively. This copolymer is referred to as “acid-labile group-containing resin (A-8)”.

### Example 15

The copolymer was obtained in the same manner as in Example 14 with the exception of replacement 1.5 g of p-toluenesulfonic acid by 0.5 g of 35% hydrochloric acid aqueous solution. The Mw of the copolymer and the molar ratio of the recurring unit are same as Example 14. This copolymer is referred to as “acid-labile group-containing resin (A-9)”.

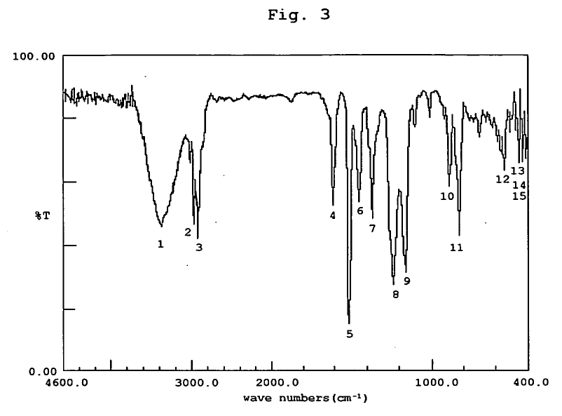

The FT-IR chart of the acid-labile group-containing resin (A-9) shown in FIG. 3. The measurement samples were prepared by KBr method. In the KBr method, potassium bromide crystal added to the resulting resin powder, and ground the mixture in a mortar. The ground mixture of resin and potassium bromide was applied pressure with press tool to obtain a transparent tablet as measurement sample. The measurement condition is in the environmental atmosphere and at room temperature.

In FIG. 3, the wave numbers (cm⁻¹) and transmittances (%) of each peaks of No. 1 to 15 are respectively as follows. Peak 1: 3301.52 and 46.6, Peak 2: 2976.43 and 40.7, Peak 3: 2926.20 and 44.3, Peak 4: 1612.64 and 54.2, Peak 5: 1512.33 and 17.0, Peak 6: 1440.57 and 55.7, Peak 7: 1367.65 and 50.0, Peak 8: 1236.40 and 29.3, Peak 9: 1159.32 and 33.4, Peak 10: 893.12 and 60.3, Peak 11: 831.39 and 44.1, Peak 12: 542.05 and 65.6, Peak 13: 449.45 and 60.5, Peak 14: 420.24 and 60.2, Peak 15: 408.95 and 69.1.

Each absorption peaks such as (—OH), (phenyl C—H), and (C—O—C) shown in FIG. 3 confirmed production of the copolymer consisted of p-hydroxystyrene, styrene, and p-t-butoxystyrene.

### Example 16

A solvent refluxed for six hours in the presence of sodium metal and after that distilled under nitrogen atmosphere was used. Monomers were used after bubbling dry nitrogen for one hour, followed by distillation. 26.5 g of p-(1-ethoxy) ethoxystyrene, 22.0 g of p-t-butoxystyrene, and 1.4 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 47.4 ml of n-butyllithium (1.83 mol/l cyclohexane solution) and 15.68 g of N,N,N′,N′-tetramethylethylenediamine were added in this order. The mixture was reacted for one hour while maintaining the temperature at −20° C. Then, 16.0 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred at 50° C. for 15 minutes to be hydrolyzed. The resulting copolymer solution was added dropwise to 2,000 g of water to coagulate the copolymer. The produced white powder was filtered and dried overnight at 50° C. under reduced pressure.

The copolymer was found to have Mw and Mw/Mn of 1,100 and 1.1 respectively. The result of ¹³C-NMR analysis confirmed that the copolymerization molar ratio of p-hydroxystyrene, styrene, and p-t-butoxystyrene of the copolymer was 55:5:40. This copolymer is referred to as “acid-labile group-containing resin (A-10)”.

### Example 17

A solvent refluxed for six hours in the presence of sodium metal and after that distilled under nitrogen atmosphere was used. Monomers were used after bubbling dry nitrogen for one hour, followed by distillation. 29.1 g of p-(1-ethoxy) ethoxystyrene, 19.4 g of p-t-butoxystyrene, and 1.51 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 23.68 ml of sec-butyllithium (1.83 mol/l cyclohexane solution) and 7.84 g of N,N,N′,N′-tetramethylethylenediamine were added in this order. The mixture was reacted for one hour while maintaining the temperature at −20° C. Then, 50.0 g of isopentyl iodide was added to terminate the reaction. The color of the reaction solution was confirmed to turn from red to colorless. After washing with 200 g of 3 wt % oxalic acid-water, 200 g of propylene glycol monomethyl ether and 1.5 g of p-toluenesulfonic acid were added. The mixture was stirred at 50° C. for 15 minutes to be hydrolyzed. The resulting copolymer solution was added dropwise to 2,000 g of water to coagulate the copolymer. The produced white powder was filtered and dried overnight at 50° C. under reduced pressure.

The copolymer was found to have Mw and Mw/Mn of 2,000 and 1.2 respectively. The result of ¹³C-NMR analysis confirmed that the copolymerization molar ratio of p-hydroxystyrene, styrene, and p-t-butoxystyrene of the copolymer was 60:5:35. This copolymer is referred to as “acid-labile group-containing resin (A-11)”.

### Comparative Synthesis Example 5

A solvent refluxed for six hours in the presence of sodium metal and after that distilled under nitrogen atmosphere was used. Monomers were used after bubbling dry nitrogen for one hour, followed by distillation. 30.63 g of p-(1-ethoxy) ethoxystyrene, 17.87 g of p-t-butoxystyrene, and 1.51 g of styrene were dissolved in 200 g of cyclohexane. The solution was charged into a dried pressure resistant glass bottle and sealed with a crown cap with a hole having packing made of Neoprene (trade name of E.I. du Pont de Nemours and Company). After cooling the pressure resistant glass bottle to −20° C., 23.68 ml of n-butyllithium (1.83 mol/l cyclohexane solution) and 7.84 g of N,N,N′,N′-tetramethylethylenediamine were added in this order. The mixture was reacted for one hour while maintaining the temperature at −20° C. Then, 8.0 g of methanol was added to terminate the reaction. After washing with 200 g of 3 wt % oxalic acid-water, 200 g of propylene glycol monomethyl ether and 1.5 g of p-toluenesulfonic acid were added. The mixture was stirred for three hours at room temperature (23-25° C.) to be hydrolyzed only p-(1-ethoxy) ethoxystyrene. The resulting copolymer solution was added dropwise to 2,000 g of water to coagulate the copolymer. The produced white powder was filtered and dried overnight at 50° C. under reduced pressure.

The copolymer was found to have Mw and Mw/Mn of 2,300 and 1.1 respectively. The result of ¹³C-NMR analysis confirmed that the copolymerization molar ratio of p-hydroxystyrene, styrene, and p-t-butoxystyrene of the copolymer was 60:5:35. This copolymer is referred to as “acid-labile group-containing resin (α-5)”.

### Examples 18 to 23 and Comparative Examples 5 to 7

The composition solutions were prepared by mixing the components in proportions shown in Table 3. and filtered the solution using a membrane filter with a pore diameter of 200 nm. In the Table 3, “part” refers to “part by weight”. Then, the composition solutions were applied to a silicon wafer by spin coating in the Clean Track (“ACT-8”, manufactured by Tokyo Electron Ltd.). After performing PB under the conditions shown in Table 4, a resist coating with a thickness of 300 nm was formed.

Then, the resist coating was exposed using an electron beam lithography system (“HL80OD”, manufactured by Hitachi, Ltd., acceleration voltage: 50 KeV, current density: 5.0 A/cm²), and performed PEB under the conditions shown in Table 4. After performing PEB, the resist film was developed at 23° C. for one minute in a 2.38 wt % tetramethylammonium hydroxide aqueous solution by puddling, washed with water, and dried to form a resist pattern. The evaluation results of the resist are shown in Table 4.

Evaluation of resists was carried out as follows with the exception of Examples 4 to 13 and Comparative Examples 1 to 4.

Acid Generator (B):

(B-5): 2,4,6-trimethylphenyl diphenylsulfonium 4-trifluoromethylbenzenesulfonate Acid diffusion controller (C):

(C-2): N-(t-butoxycarbonyl)-2-phenylbenzimidazole

(C-3): Tri-n-octylamine

(C-4): 4-phenylpyridine

Evaluation of resists prepared by Examples 18 to 23 and Comparative Examples 5 to 7 was carried out as follows.

(4) Sensitivity (L/S):

The sensitivity was evaluated by the same manner as in Example 1 with the exception of the electron beam exposure to a resist coating formed on a silicon wafer.

(5) Resolution (L/S):

The minimum line width of line-and-space pattern (1L1S) (nm) resolved by an optimum dose of exposure was taken as the resolution.

(6) Nano-Edge Roughness:

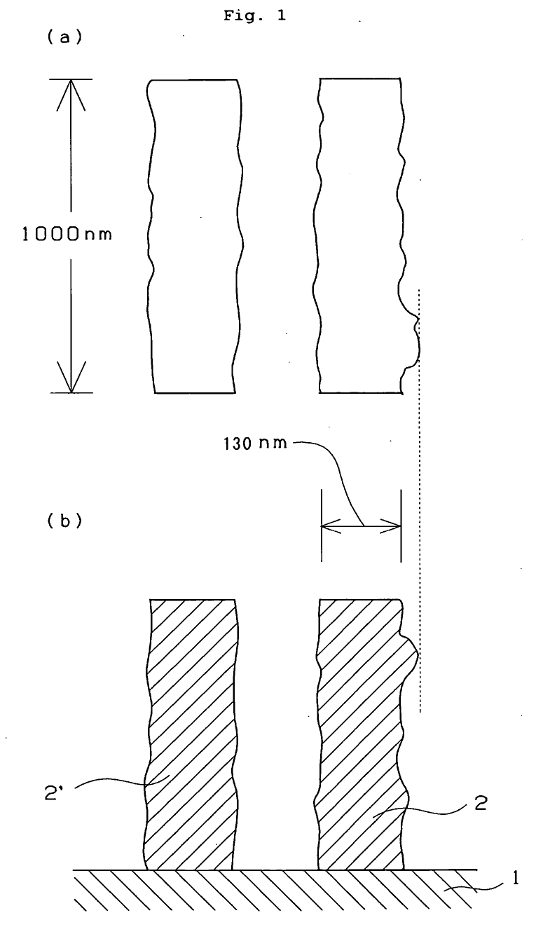

A line pattern of line-and-space pattern (1L1S) with a predetermined line width of 130 nm was observed using a CD-SEM (“S-9220” manufactured by Hitachi High-Technologies Corporation). The schematic view of line pattern is shown in FIG. 1. The edge is exaggerated shape in the figure. The critical dimension (ACD) in which a difference between the line width with markedly section occurred along the side face of the line pattern and the predetermined line width of 130 nm was determined of the profile observed in each Examples.

(7) Pattern Profile (White Edge):

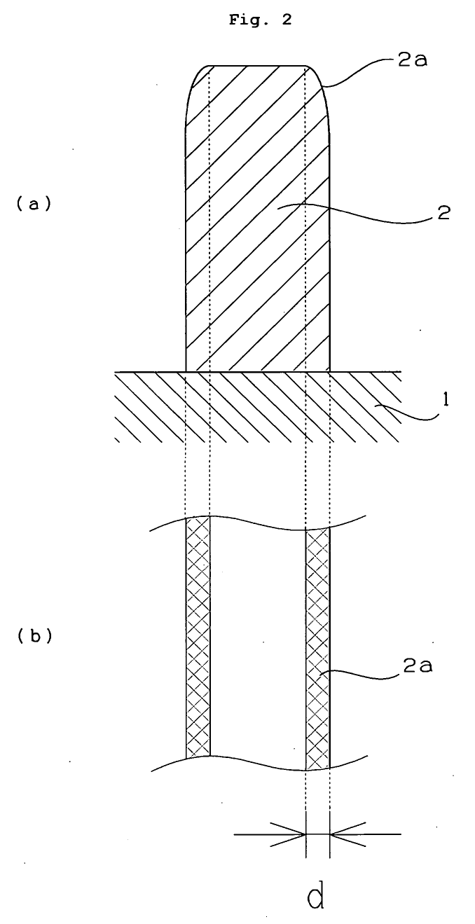

Round areas at the top of a 130 nm 1L1S pattern developed with an optimum dose of exposure was observed using a CD-SEM (“S-9220” manufactured by Hitachi High-Technologies Corporation). The width of white parts was measured. The profile is schematically shown in FIG. 2. FIG. 2(a) shows the cross-section and FIG. 2(b) is a CD-SEM photograph. A top area 2a of a pattern 2 formed on the substrate 1 is round and that area with a width d is white. The smaller the width d, the better the pattern profile.

TABLE 3

| | | | Acid | |
|---|---|---|---|---|
| | | Acid | diffusion | |
| | Resin (A) | generator (B) | controller (C) | Solvent |
| | (part) | (part) | (part) | (part) |
| Example | | | | |
| 18 | A-8(100) | B-1(9) | C-2(0.6) | D-1(800) |
| | | | | D-3(300) |
| 19 | A-9(100) | B-2(9) | C-2(0.6) | D-1(800) |
| | | | | D-3(300) |
| 20 | A-8(100) | B-2(9) | C-3(0.5) | D-1(800) |
| | | | | D-3(300) |
| 21 | A-8(100) | B-1(1) | C-1(0.6) | D-1(800) |
| | | B-2(8) | | D-2(300) |
| 22 | A-10(100) | B-2(9) | C-4(0.5) | D-1(800) |
| | | | | D-3(300) |
| 23 | A-11(100) | B-5(9) | C-3(0.5) | D-1(800) |
| | | | | D-3(300) |
| Comparative | | | | |
| Example | | | | |
| 5 | α-1(100) | B-2(9) | C-3(0.5) | D-1(800) |
| | | | | D-3(300) |
| 6 | α-2(100) | B-2(9) | C-3(0.5) | D-1(800) |
| | | | | D-3(300) |
| 7 | α-5(100) | B-2(9) | C-3(0.5) | D-1(800) |
| | | | | D-3(300) |

TABLE 4

| | | | | | | | Nano-edge | Pattern |
|---|---|---|---|---|---|---|---|---|
| | PB | | PEB | | Resolution | Sensitivity | roughness | profile |
| | (° C.) | (second) | (° C.) | (second) | (nm) | (μC/cm²) | (nm) | (nm) |
| Example | | | | | | | | |
| 18 | 90 | 90 | 90 | 90 | 90 | 10.6 | 8 | 5 |
| 19 | 90 | 90 | 90 | 90 | 90 | 10.1 | 8 | 5 |
| 20 | 90 | 90 | 90 | 90 | 90 | 10.5 | 8 | 5 |
| 21 | 90 | 90 | 90 | 90 | 90 | 10.6 | 8 | 5 |
| 22 | 90 | 90 | 90 | 85 | 85 | 10.2 | 7 | 4 |
| 23 | 90 | 90 | 90 | 90 | 90 | 10.7 | 8 | 4 |
| Comparative Example | | | | | | | | |
| 5 | 90 | 90 | 90 | 90 | 110 | 12.0 | 13 | 22 |
| 6 | 90 | 90 | 90 | 90 | 110 | 11.5 | 12 | 20 |
| 7 | 90 | 90 | 90 | 90 | 90 | 11.0 | 10 | 7 |

The radiation-sensitive resin composition of the present invention exhibits high resolution and exposure latitude, and excels in pattern collapse margin, while preserving excellent basic characteristics as a resist such as pattern profile, dry etching resistance, and heat resistance. The composition can be suitably used in the field of microfabrication represented by the manufacture of integrated circuit devices which are expected to become more and more miniaturized in the future.

1. A phenolic hydroxyl group-containing copolymer comprising a recurring unit which is hydrolyzed with an acid after copolymerizing a monomer of the following formula (1) and a recurring unit which is hydrolyzed with the acid after copolymerizing a monomer of the following formula (2),
wherein an acid-labile group of the monomer of the formula_(1) is hydrolyzed completely, and an acid-labile group of the monomer of the formula_(2) is hydrolyzed partially, 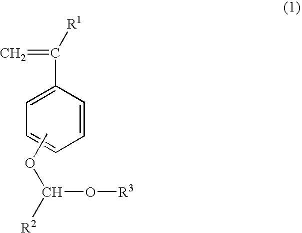
wherein R¹ represents a hydrogen atom or a methyl group, and R² and R³ represent saturated hydrocarbon groups having 1-4 carbon atoms or bond together to form a cyclic ether having 3-7 carbon atoms, 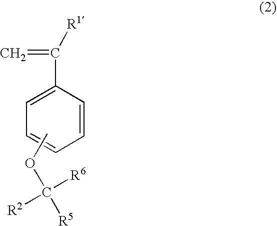
wherein R^{1′} represents a hydrogen atom or a methyl group, and R⁴, R⁵, and R⁶ represent saturated hydrocarbon groups having 1-4 carbon atoms.

2. The copolymer according to claim 1, wherein a polystyrene-reduced weight average molecular weight of the copolymer determined by gel permeation chromatography (GPC) is not less than 500 and less than 12,000.

3. The copolymer according to claim 2, wherein a polystyrene-reduced weight average molecular weight of the copolymer determined by gel permeation chromatography (GPC) is not less than 500 and less than 10,000.

4. The copolymer according to claim 3, wherein a polystyrene-reduced weight average molecular weight of the copolymer is not less than 500 and not more than 2,000.

5. The copolymer according to claim 1, wherein the copolymer comprises a recurring unit derived from a styrene monomer with the recurring units derived from the monomers of the formula (1) and the formula (2).

6. The copolymer according to claim 1, wherein the copolymer is copolymerized with the monomers by an anionic polymerization.

7. The copolymer according to claim 6, wherein a catalyst in the anionic polymerization is a butyllithium.

8. The copolymer according to claim 1, wherein the acid is p-toluenesulfonic acid or hydrochloric acid.

9. A phenolic hydroxyl group-containing copolymer consisting essentially of a recurring unit which is hydrolyzed with an acid after anionic-copolymerizing a monomer of the following formula_(1) and a recurring unit which is hydrolyzed with an acid after anionic-copolymerizing a monomer of the following formula (2), wherein an acid-labile group of the monomer of the formula_(1) is hydrolyzed completely, and an acid-labile group of the monomer of the formula_(2) is hydrolyzed partially, 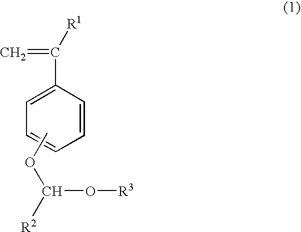
wherein R¹ represents a hydrogen atom or a methyl group, and R² and R³ represent saturated hydrocarbon groups having 1-4 carbon atoms or bond together to form a cyclic ether having 3-7 carbon atoms, 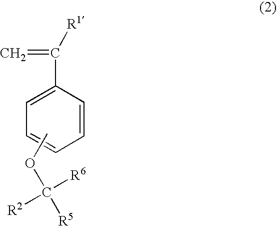
wherein R^{1′} represents a hydrogen atom or a methyl group, and R⁴, R⁵, and R⁶ represent saturated hydrocarbon groups having 1-4 carbon atoms.

10. The copolymer according to claim 9, wherein the acid is p-toluenesulfonic acid or hydrochloric acid.

11. The copolymer according to claim 9, wherein the copolymer consists essentially of a recurring unit derived from a styrene monomer and the recurring units derived from the monomers of the formula_(1) and the formula (2).

12. The copolymer according to claim 11, wherein the acid is p-toluenesulfonic acid or hydrochloric acid.

13. The copolymer according to claim 12, wherein a polystyrene-reduced weight average molecular weight of the copolymer determined by gel permeation chromatography (GPC) is not less than 500 and less than 12,000.

14. The copolymer according to claim 13, wherein a polystyrene-reduced weight average molecular weight of the copolymer determined by gel permeation chromatography (GPC) is not less than 500 and less than 10,000.

15. The copolymer according to claim 14, wherein a polystyrene-reduced weight average molecular weight of the copolymer is not less than 500 and not more than 2,000.

16. A phenolic hydroxyl group-containing copolymer comprising a recurring unit which is hydrolyzed with an acid after copolymerizing a monomer of the following formula_(1) and a recurring unit which is hydrolyzed with the acid after copolymerizing a monomer of the following formula (2),
wherein a polystyrene-reduced weight average molecular weight of the copolymer is not less than 500 and not more than 2,000, 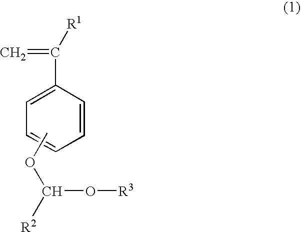
wherein R¹ represents a hydrogen atom or a methyl group, and R² and R³ represent saturated hydrocarbon groups having 1-4 carbon atoms or bond together to form a cyclic ether having 3-7 carbon atoms, 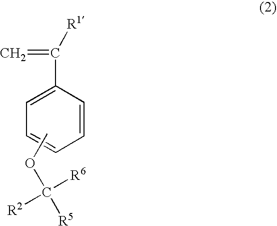
wherein R^{1′} represents a hydrogen atom or a methyl group, and R⁴, R⁵, and R⁶ represent saturated hydrocarbon groups having 1-4 carbon atoms.

17. The copolymer according to claim 16, wherein the copolymer is copolymerized with the monomers by an anionic polymerization.

18. The copolymer according to claim 16, wherein the copolymer comprising a recurring unit derived from a styrene monomer with the recurring units derived from the monomers of the formula (1) and the formula (2).

19. A radiation-sensitive resin composition comprising an acid-labile group-containing resin which is insoluble or scarcely soluble in alkali, but becomes alkali soluble by the action of an acid, and a photoacid generator, wherein the acid-labile group-containing resin comprises a copolymer according to claim 1.

20. A radiation-sensitive resin composition comprising an acid-labile group-containing resin which is insoluble or scarcely soluble in alkali, but becomes alkali soluble by the action of an acid, and a photoacid generator, wherein the acid-labile group-containing resin comprises a copolymer according to claim 16.
